(19) United States
(12) Patent Application Publication
(10) Pub. No.: US 2001/0052943 A1
(43) Pub. Date: Dec. 20, 2001

(54) Multimedia system with synchronization of music and image tracks

(76) Inventor: Takurou Sone, Shizuoka-ken (JP)

Correspondence Address: David L. Fehrman, Morrison & Foerster LLP, 35th Floor, 555 W. 5th Street, Los Angeles, CA, 90013-1024, US

(21) Appl. No.: 09/871,543

(22) Filed: May 31, 2001

(30) Foreign Application Priority Data
Jun. 2, 2000 (JP) 2000-166719

(51) Int. Cl. H04N 7/00; H04N 11/00

(52) U.S. Cl. 348/552

(57) ABSTRACT

A multimedia system has a file storage, a sequencer, a program storage and an executing unit. The file storage stores a multimedia file composed of sequence tacks including a performance sequence track recording performance sequence information and a drawing sequence tack recording drawing sequence information, and a synchronization means recording synchronization information effective to synchronize the sequence tracks with one another. The sequencer processes the multimedia file for parallel running of the sequence tracks synchronously with each other according to the synchronization information. The program storage stores an application program which treats and controls the multimedia file. The executing unit executes the application program to enable the application program to communicate with the sequencer for effecting a control of the parallel running of the sequence tracks including a start control and a stop control of the parallel running of the sequence tracks.

### BACKGROUND OF THE INVENTION

The present invention relates to a multimedia execution system for handling various types of multimedia information such as sound, image, and text.

For example, browser software (hereinafter referred to as a browser) of contents on Internet handles multimedia information totally as seen from a user side. A user can operate this browser on a personal computer screen to handle the multimedia information such as sound, image text on a solo screen. Respective pieces of information are usually stored in places defined by different paths in a server, and the browser individually extracts the respective pieces of information and reproduces the information on the same screen. It is possible to handle all the information on Internet with a hyper text markup language (HTML), and the browser interprets the HTML to output or reproduce the information.

Moreover, a software, described in a language different from the HTML, for synchronizing and reproducing the sound and image (especially a dynamic image) is also brought to practical use on Internet. In a file structure handled by the software, sound information is integral with image information, and the structure can be handled as one file.

However, for the multimedia information which can be described in the HTML, the information stored in a specific place is only statically read and reproduced. Each information is neither synchronized nor dynamically reproduced. Therefore, it is impossible to sophistically control the contents and completely synchronize and reproduce especially the image or the sound with time.

Moreover, in a conventional art where sound information and image information are handled in one file form, each information is completely independently reproduced from the beginning. Therefore, there is a disadvantage that the information cannot be jumped midway or that the information cannot finely be synchronized with each other.

### SUMMARY OF THE INVENTION

An object of the present invention is to provide a multimedia execution system in which handling of the multimedia information is remarkably facilitated and fine synchronization control between the respective information is realized.

To solve the aforementioned problem, the present invention is constituted as follows.

(1) The constitution of the present invention comprises a storage section of a multimedia file in which a performance sequence track for storing performance sequence information, a drawing sequence track for storing drawing sequence information, and synchronization information storage means for storing synchronization information of the respective sequence tracks are incorporated in the same file, a sequencer for executing a running operation of the multimedia file, a storage section of an application program for performing communication with the sequencer to control an execution start, an execution stop, and an execution of the multimedia file, and a program execution section for executing the application program.

In the multimedia file for use in the system of the present invention, synchronization information recording means in which a plurality of sequence tracks with a plurality of types of information recorded therein are recorded together with the synchronization information of each sequence track is incorporated in the same file. The synchronization information recording means is preferably structured to have the same type of sequence track as that of the aforementioned sequence track. The plurality of types of information include performance sequence information and drawing sequence information, and can further include audio sequence information. The performance sequence information is usually MIDI or sequence information equivalent to MIDI, and the drawing sequence information can include text, bitmap data and image data. The audio sequence information can be constituted of adaptive differential pulse code modulation (ADPCM) data. Moreover, the information can also be constituted of compressed audio data such as TwinVQ (trademark) and MP3.

The multimedia execution system of the present invention is provided with the storage section for storing the multimedia file, the sequencer for executing the running operation of the multimedia file, the storage section of the application program for performing communication with the sequencer to control the execution start, execution stop and execution of the multimedia file, and the program execution section for executing the application program. Thereby, during the running operation, the respective sequence track information are synchronized in accordance with the synchronization information. Therefore, the synchronization of the information between the respective sequence tracks can finely be set by a way of describing the synchronization information. Moreover, when the sequencer and application program communicate with each other, and the running operation is controlled in accordance with the synchronization information, the information can be known by the application program. Thereby, various controls can be performed on the synchronization information by the application program.

(2) The multimedia file has a master track for performing the same running operation as that of each sequence track as the synchronization information storage means, and stores control information of a time axis direction for stopping, branching and repeating the running operation of each sequence track as the synchronization information.

Since the master track for performing the same running operation as that of each sequence track is disposed as the synchronization information storage means for storing the synchronization information, description of the synchronization information is facilitated. Moreover, since the control information of the time axis direction for stopping, branching, or repeating the running operation of each sequence track is stored as the synchronization information, in the midst of the running operation the desired control is enabled during the communication with the application program. For example, when the control information for stopping the running operation is stored as the synchronization information, the user can input the data or specific data can be transmitted or requested with respect to the server with the application program at the corresponding timing. Thereby, the running operation can be controlled based on the user's input or the information from the server during the running operation. For example, when the information for stopping the running operation is stored as the synchronization information, a branch destination can be designated in accordance with the user's input at the corresponding timing. Moreover, when commercial information is recorded in the drawing sequence track, and when running operation stop information is recorded as the synchronization information at a commercial end timing, the server can be notified of a commercial end.

(3) The drawing sequence track is constituted by describing a display event for designating a display object and a duration for designating a time interval between the display events, and the display event enables a plurality of coordinate representation formats of the display object to be designated.

For the multimedia file of the present invention, in the drawing sequence track, the coordinate representation format of the display object defined in the display event can be designated from a plurality of coordinate representation formats. Therefore, it is possible to designate an optimum display position with respect to a display device for use at the time. When at least a layout information designation form for designating a display position with a ratio based on a screen size and display object size is included as a display form, a display object reduced scale is automatically determined in accordance with the screen size.

For the display event, the plurality of coordinate representation formats of the display object can be designated in this manner. Therefore, the optimum display position can be designated with respect to the display device for use at the time. This broadens a range of circulation of the multimedia file (contents).

(4) The display event includes a primary block in which display object definition information including a type of the display object is described, and a secondary block in which display modification sequence information for adding a dynamic display modification to a content represented by the primary block is described, and the display modification sequence information is constituted of one or more pieces of display modification sequence information arbitrarily selected from a plurality of pieces of display modification sequence information which do not influence one another in operation.

In the present invention, the primary block for defining basic information of the display object, and the secondary block including the display modification sequence information for adding the dynamic display modification to the content represented by the primary block can be described in the display event. In this case, since the operation of the display modification sequence information does not influence the operation of the other synchronization modification sequence information. Therefore, it is possible to easily combine optimum display modification sequence information in accordance with movement of the display object. When each display modification sequence information is set as simple function representation information, a complicated movement of display content can easily be presented with combination of simple function representations. Moreover, this facilitates preparation of the contents.

### BRIEF DESCRIPTION OF THE DRAWINGS

FIG. 1 is a schematic constitution diagram of hardware of a multimedia execution system according to an embodiment of the present invention.

FIG. 2 is a software constitution diagram of the multimedia execution system.

FIG. 3 is a diagram showing a running operation of the system.

FIG. 4 is a flowchart schematically showing an operation of a sequencer and application program.

FIG. 5 is an explanatory view of a function of a master track.

FIG. 6 is a diagram showing a coordinate representation format of a display event.

FIG. 7 is a diagram showing general description contents of the display event.

### DETAILED DESCRIPTION OF THE INVENTION

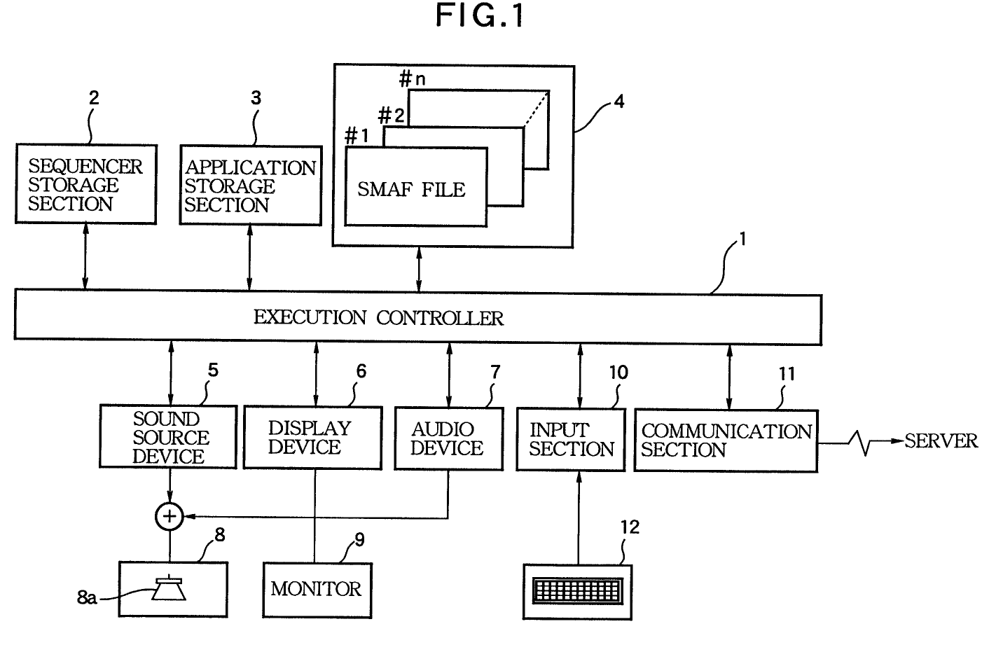

FIG. 1 is a hardware constitution diagram of a multimedia execution system according to an embodiment of the present invention. The inventive multimedia execution system may be practiced in various forms such as a computer terminal device, a portable terminal device and a portable telephone, all of which have the hardware structure shown in FIG. 1.

An execution controller 1 includes CPU, ROM, RAM, and the like, and performs execution of a sequencer (program) and an application program, control of an input/output, and the like. The execution controller 1 is connected to a sequencer (program) storage section 2, an application (program) storage section 3, and a storage section 4 in which a multimedia file is stored. For the multimedia file, as described later, a performance sequence track, drawing sequence track, audio sequence track, master track, and contents information storage section are incorporated in the same file. In the present embodiment, this file will be referred to as a synthetic music mobile application format (SMAF) file. First to n-th SMAF files are stored in the storage section 4, and any SMAF file is selected in accordance with input information from the application storage section 3 or a user.

The execution controller 1 is connected to a sound source device 5, display device 6, and audio device 7.

Performance sequence information in the SMAF file is inputted to the sound source device 5, and converted to a music performance signal in the device. The performance sequence information is MIDI sequence information in the present embodiment, and an MIDI sound source device is used in the sound source device 5.

Drawing sequence information in the SMAF file is inputted to the display device 6. The drawing sequence information is visual information selected from a text, binary image, and desired image as described later. The display device 6 converts the information to an image signal.

The audio device 7 receives audio sequence information in the SMAF file, and converts the information to an audio signal. In the present embodiment, the audio sequence information is ADPCM information, and the audio device 7 converts the ADPCM information to an analog audio signal.

A musical tone/voice output section 8 outputs synthesized outputs of the sound source device 5 and audio device 7 via a speaker 8a. A monitor 9 displays an image output from the display device 6 on a display screen.

The execution controller 1 is further connected to an input section 10 and communication section 11. The input section 10 is connected to an operation section 12 including a keyboard, mouse, and the like, and the communication section 11 is connected to an external server via a communication circuit, which may be a wireless or wired computer network such as Internet, or a public communication network.

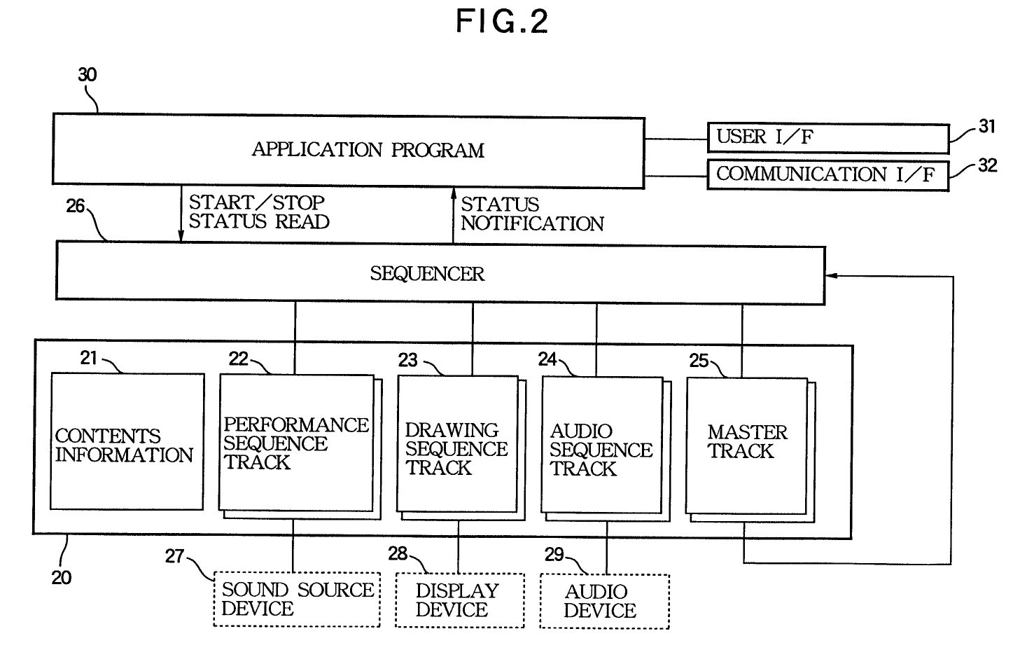

FIG. 2 is a software constitution diagram of the multimedia execution system.

Reference numeral 20 denotes SMAF file. The SMAF file 20 is constituted of contents information storage section 21, performance sequence track 22, drawing sequence track 23, audio sequence track 24, and master track 25, and these tracks are integrally incorporated in one file.

The contents information storage section 21 stores information concerning contents of the whole SMAF file 20. The performance sequence track 22 stores performance sequence information, the drawing sequence track 23 stores drawing sequence information, and the audio sequence track 24 stores audio sequence information, respectively. The master track 25 stores synchronization information of the respective sequence tracks 22 to 24. The master track 25 stores the synchronization information of the respective sequence tracks 22 to 24, and the track 25 itself is one of a sequence track.

A sequencer 26 controls running operations of these performance sequence track 22, drawing sequence track 23, audio sequence track 24, and master track 25. Each of the sequence tracks is constituted by combining an event and a duration, and the duration designates a time interval between the successive events. Therefore, an event execution start time can be known by accumulating the duration from the top of the sequence track. Moreover, even when processing of the event itself takes much time, an elapse of time on the sequence data is not influenced. The elapse of time can be represented by the duration regardless of the event processing. As described later in detail, the master track 25 stores control information along the time axis, such as a pause (stop) event, branch event, and repetition event as the synchronization information. When these events occur, the master track 25 instructs the sequencer 26 to perform pause, branch, repetition, or another sequence control. For example, when the pause event is generated, the running operations of the respective sequence tracks 22 to 25 temporarily stop. Moreover, when the branch event is generated, a running operation point of each sequence track is simultaneously branched to a specific position.

A sequential output of the performance sequence track 22 is inputted to a sound source device 27, and outputted as a sound. An output of the drawing sequence track 23 is outputted to a display device 28, and is drawn on the display monitor. An output of the audio sequence track 24 is outputted to the audio device 29, and outputted as a sound.

The sequencer 26 is controlled by an application program 30. The application program 30 may be of any type program as long as the sequencer 26 can be controlled. The application program 30 outputs a start/stop signal or a status read signal to the sequencer 26. Moreover, the sequencer 26 notifies a status (state) to the application program 30. For example, when the pause event is generated as the event of the master track 25, the sequencer 26 brings the running operation to a pause state (temporary stop state), and notifies the current status to the application program 30, and the application program 30 reads the status content. In this case, the status content is a pause (temporary stop). The application program 30 performs a predetermined display to the user via a user interface 31, or waits for an input operation from the user in accordance with the status content. Moreover, the application program exchanges data with the server via a communication interface 32. When an event is generated after the pause state (this event is determined by the application program 30, when there is a user input), the application program 30 instructs the sequencer 26 to restart.

Data communication is performed between the sequencer and the application program in this manner.

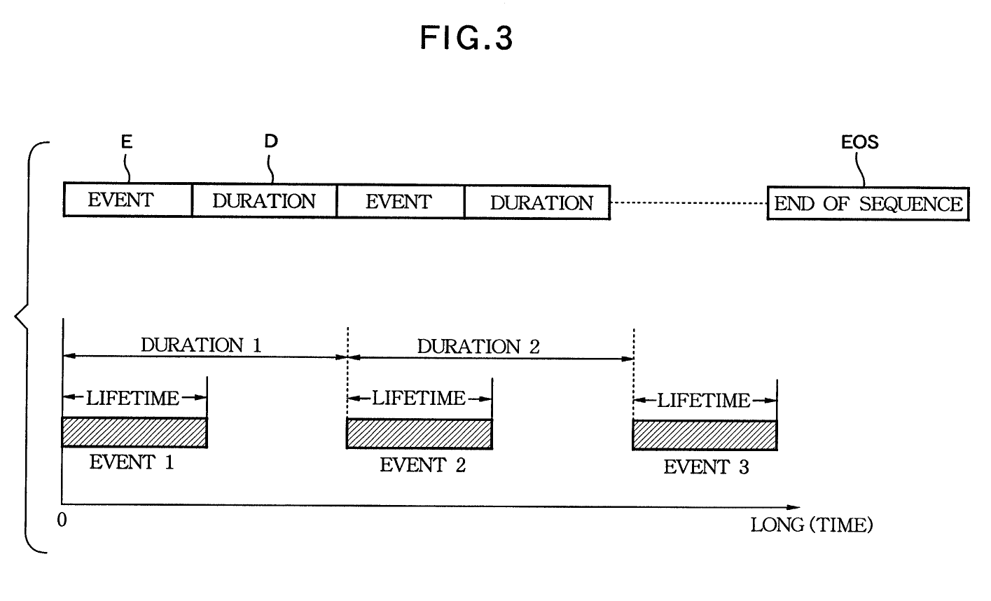

FIG. 3 shows a data structure of the sequence track.

As described above, the sequence data is represented by combining and describing an event E and duration D. A data string starts with the event E, and sequence end data EOS is disposed in a data terminal end. Lifetime indicates an event effective length. For example, with the performance sequence information, sound generation time is indicated. The duration D designates the time interval between the successive events. Therefore, the start time of a specific event can be determined by accumulating duration values from the top of data. For example, the start time of an event 3 is obtained by adding an accumulated value of durations 1 and 2 to time 0. Moreover, to branch to the event 1 from the start time of the event 3, the summed value of durations 1 and 2 is subtracted from the start time of the event 3. The running operation of each sequence track can arbitrarily be controlled by this method. The control contents, that is, the synchronization information of each sequence track is described in the master track 25. Additionally, in the present embodiment, the event E and duration D are alternately recorded in the sequence track, but they may not necessarily alternately be recorded.

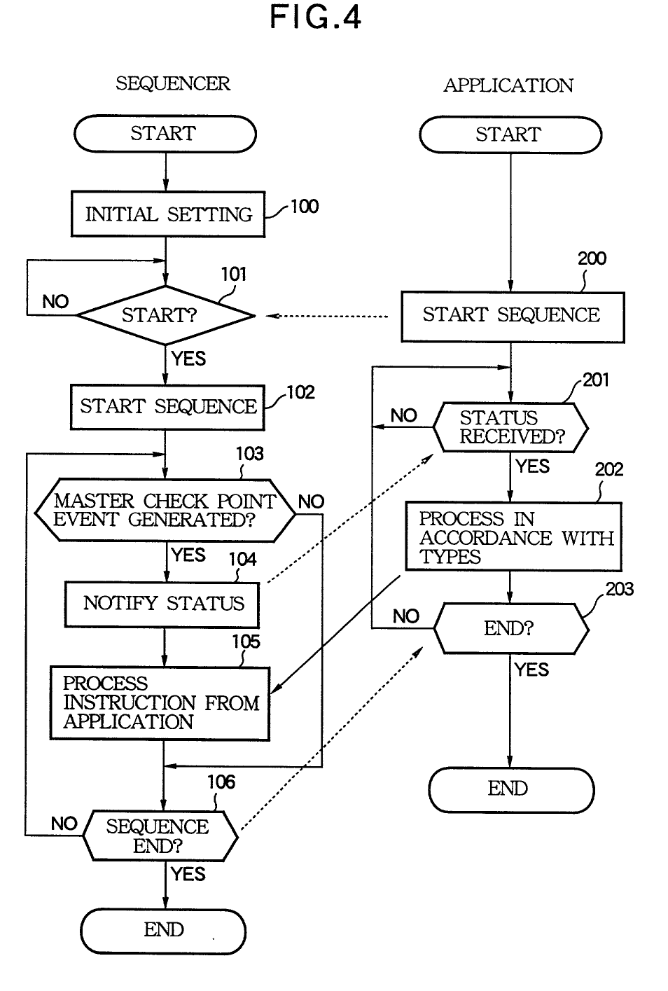

FIG. 4 schematically shows the operation of the sequencer 26 and application program 30.

After a processing starts and the sequencer 26 performs initial setting (step 100), the sequencer waits for a running operation start. When a sequence start order is received from the application program 30 (step 200) (step 101), the running operation in the sequencer 26 starts (step 102), and the event generation of the master track 25 is monitored (step 103). The event of the master track 25 will be referred to as a check point event or control event. When the check point event is generated, the sequencer 26 performs status notification to the application program 30, and transmits the content of the check point event (step 104). In step 201, the application program receives the status and performs a processing in accordance with the content (step 202). For example, when the check point event is the pause event, the application program performs a processing of waiting for an input from the user in response to the pause event. Alternatively, the application program downloads specific data from the server or uploads specific data via the communication interface 32 in response to the pause event. The application program 30 further transmits a predetermined instruction to the sequencer 26 in accordance with the processing of the step 202. That is, the application program controls each sequence track in accordance with the input content from the user or the data from the server. In step 105, the sequencer 26 performs a processing corresponding to the instruction from the application program 30. When the aforementioned processing is performed, and the sequence does not end, the sequencer 26 performs the operation of the step 103 and subsequent steps. When the program does not end, the application program 30 returns to the step 201 again.

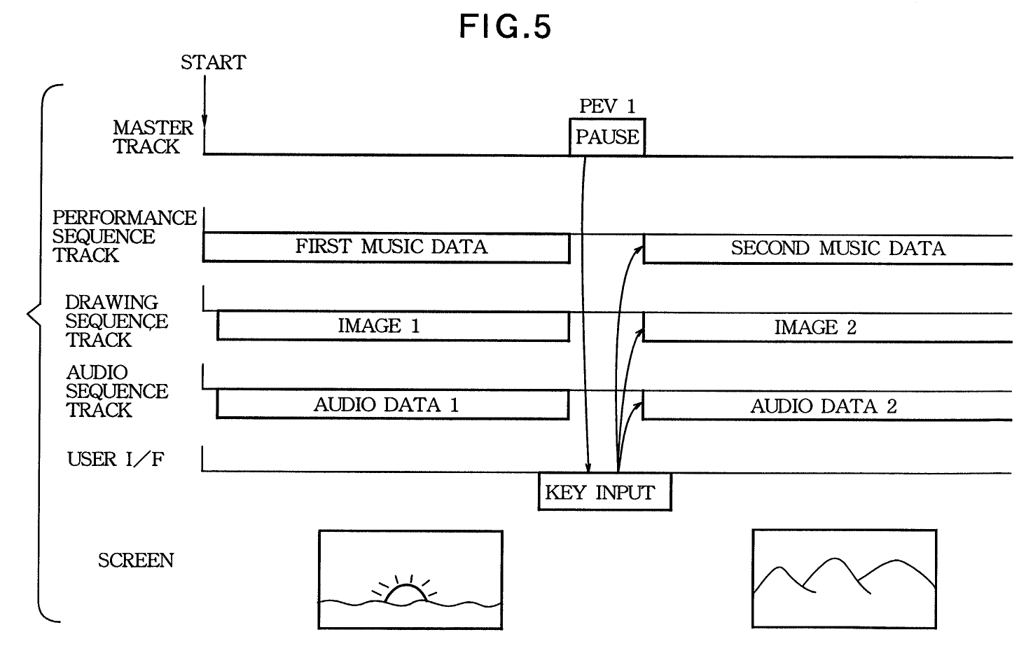

FIG. 5 shows an operation example along a time axis. When the running operation starts, the running operations of the performance sequence track 22, drawing sequence track 23, audio sequence track 24 and master track 25 simultaneously start from the top, and reproduction is performed in accordance with each sequence content. It is now assumed that contents are constituted of music data, image data, and audio data. Then, when a pause event PEV1 of the master track 25 is generated, the running operation in the sequencer 26 stops, and the application program 30 waits for the user input from the user interface. Here, when there is a specific key input, the application program 30 issues a start order, and subsequently starts reproducing of second music data, image 2, and audio data 2.

In FIG. 1 and FIG. 2, since the SMAF file 20 is independent of the sequencer 26 and application program 30, the SMAF file 20 can be distributed via a desired storage medium and transmission medium. Moreover, since the application program 30 is also a program independent of the sequencer 26, a desired function can be imparted to the program. Therefore, contents distribution capability is high, and expansion property, and freedom degree of the whole system are remarkably great.

Additionally, examples of the check point event of the master track 25 include not only the aforementioned pause event but also the branch event and repetition event. The branch event has an instruction for branching to a desired position on the time axis, and the repetition event has an instruction for repeating a constant sequence period. Additionally, it is possible to store various control information along the time axis direction in the form of the check point event.

An event description system of the drawing sequence track 23 will next be described.

As described above, the format of the drawing sequence track 23 is also constituted by alternately describing the event (display event) and the duration for designating the time interval between the display events.

The display event needs to designate a display position of a display object. In the present embodiment, for the display event, a coordinate representation format of the display object can be selected from a plurality of formats.

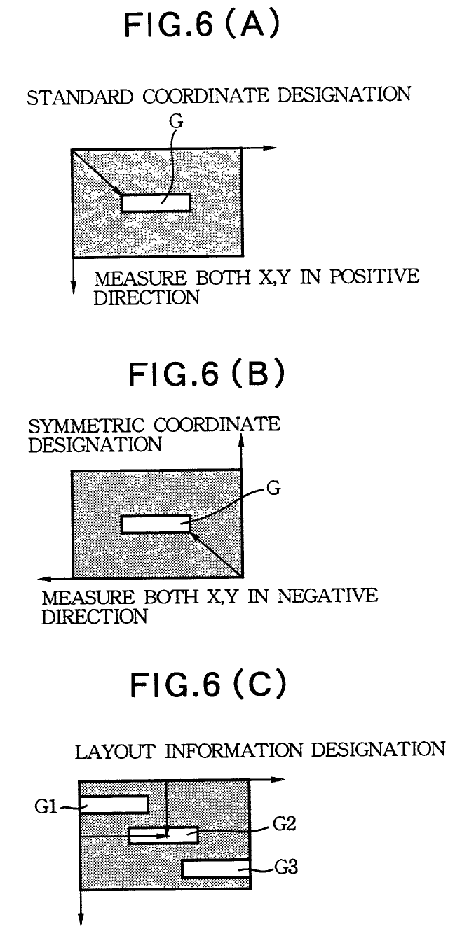

FIG. 6 shows selectable coordinate representation formats. FIG. 6(A) shows the representation format of standard coordinate designation, (B) shows that of symmetric coordinate designation, and (C) shows that of layout information coordinate designation.

In the standard coordinate designation, a coordinate origin is set to a left upper point of the display screen, a rightward direction of X axis is set as a positive direction, and a downward direction of Y axis is set as the positive direction. Moreover, a left upper coordinate of a display object G is designated.

In the symmetric coordinate designation, the coordinate origin is set to a right lower point of the display screen, a leftward direction of X axis is set as the positive direction, and an upward direction of Y axis is set as the positive direction. Moreover, a right lower coordinate of the display object G is designated.

In the layout information coordinate designation, positions are designated in a percentage in both X and Y directions. In the X direction, 0 indicates a left position, 50 indicates a center position, and 100 indicates a right position. Moreover, in the Y direction, 0 indicates an upper position, 50 indicates a center position, and 100 indicates a lower position. In an example shown in FIG. 6(C), a display object G1 is in the left position in the X direction, G2 is centered in the X direction, and G3 is in the right position in the X direction.

Additionally, any coordinate representation format can be designated independently in X and Y coordinates.

Since the coordinate representation format can be selected from a plurality of formats in this manner, the forms suitable for a plurality of types of display monitors can be selected. For example, when the coordinate representation format of the layout information coordinate designation is selected, and even when the SMAF file is applied to systems having different areas of the display screen, the same display state can be obtained. Moreover, when one object is designated to be applicable to either the standard coordinate designation or the symmetric coordinate designation, the designation can be selected in accordance with the position of the display object in such a manner that the designation can more easily be performed. This produces an advantage that preparation of the sequence data is facilitated.

Moreover, the designated coordinate representation format is retained as a default representation format until a new coordinate representation format is next designated. Therefore, only when the coordinate representation format changes, the new coordinate representation format may be designated, and good readability of the sequence data and saving of memory consumption can be achieved.

Furthermore, in the present system, complicated movement can be represented by devising a method of describing the display event. The method will be described hereinafter in detail.

The display event includes a primary block in which display object definition information including a type, size and content of the display object is described, and a secondary block in which display modification sequence information for adding dynamic modification to a display object represented by the primary block is described.

The primary block includes basic information, which is therefore information essential for the display event. The secondary block is a block which can appropriately be selected.

Moreover, the display modification sequence information of the secondary block is constituted of one or more pieces of display modification sequence information freely selected from a plurality of pieces of display modification sequence information which do not influence or interfere with one another in operation.

The type, size, and content of the display object are described in the display object definition information recorded in the primary block. Examples of types of the display object include a text, bitmap data and image data.

Examples of the display modification sequence information include the following.

(1) Image conversion sequence (change of display content)

(a) Color change sequence

For example, an image color of a karaoke or singalong machine is changed. A displayed text or the like is changed with time. Flashing of images such as a neon sign can also be represented.

(b) Image deformation sequence

The image is changed with time.

(2) Banner sequence (designation of method of projection onto display screen)

(a) A character string is arranged and displayed into a display frame.

(b) A part of the display frame is projected, and a projected position is changed with time and displayed.

(3) Movement sequence (change of display position)

(a) A position on the screen in which the display frame is displayed is changed with time.

(4) Display window change sequence

(a) A size of the display frame is changed with time.

(5) Display changeover sequence

(a) When a plurality of primary blocks are designated, these blocks are changed.

(b) Two display object images (images appearing on the screen) are changed with time and displayed.

For example, there are wipe transition (the image is wiped from left to right direction and changed), dissolve transition (wiping operation is performed in a plurality of divided segments of the screen), fading transition (the screen is changed in such a manner that the first screen disappears), and the like.

The aforementioned display modification sequence information do not influence one another in operation. Therefore, even when two or more pieces of display modification sequence information are combined, actions realized by the individual sequence information are simply added. Therefore, the following display modification can be performed by combining a plurality of pieces of display modification sequence information.

(1) Color change+banner

(a) While a telop runs in the display frame, a telop color changes midway.

(2) Color change+banner+movement

(a) While the telop runs in the display frame, the telop color changes midway, and further the display frame position moves with time.

(3) Color change+banner+movement+display window change

(a) While the telop runs in the display frame, the telop color changes midway, further the display frame position moves with time, and additionally the display frame is reduced in size with time to disappear or reappear.

As described above, each display modification sequence information has a function of exerting no mutual interference, and desired information can be selected from the plurality of pieces of display modification sequence information.

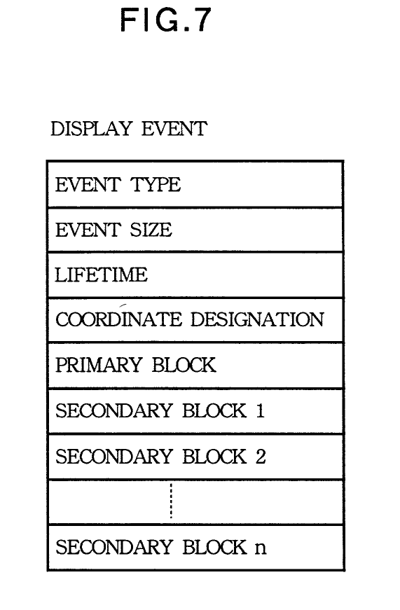

FIG. 7 shows a general description form of the display event. An event type, event size, lifetime, coordinate designation, primary block, and desired number of secondary blocks are described from top to bottom. The secondary block is optional, and at least the primary block may be described. However, when the secondary block is described, various representations can easily be realized as noted above.

Additionally, in the aforementioned embodiment, the master track is used in the synchronization information recording means, but the synchronization information may be written in each sequence track.

According to the present invention, synchronization information recording means in which each sequence track synchronization information is recorded together with a plurality of sequence tracks with a plurality of types of information recorded therein is incorporated in the same file to constitute a multimedia file. Therefore, synchronization is established among the respective sequence tracks in accordance with the synchronization information during a running operation. Therefore, the synchronization of the information among respective sequence tracks can finely be controlled by way of describing the synchronization information.

Moreover, when a sequencer communicates with an application program, and the running operation is controlled in accordance with the synchronization information, the application program can recognize the information. Thereby, the application program can perform various controls with respect to the synchronization information.

Furthermore, since a master track having the same structure as that of each sequence track is disposed as synchronization information storage means for storing the synchronization information, description of the synchronization information is facilitated.

Additionally, since a display event can designate a plurality of coordinate representation formats of a display object, it is possible to designate a display position optimum for a display device for use at the time. This can broaden a distribution range of contents.

Moreover, the display event can be described with a primary block for defining basic information of the display object, and a secondary block including display modification sequence information combinations for imparting a dynamic display modification to the display object represented by the primary block. Moreover, the display modification sequence information is information which exerts no mutual operation influence. Therefore, it is possible to easily combine optimum display modification sequence information in accordance with movements of the display object. Since each display modification sequence information is of simple function representation, complicated movement of a displayed content can easily be presented with the combination of simple function representations. Moreover, this produces an effect that contents preparation is also facilitated.

What is claimed is:

1. A multimedia system comprising:
a file storage that stores a multimedia file composed of sequence tacks including a performance sequence track recording performance sequence information and a drawing sequence tack recording drawing sequence information, and a synchronization means recording synchronization information effective to synchronize the sequence tracks with one another;
a sequencer that processes the multimedia file for parallel running of the sequence tracks synchronously with each other according to the synchronization information;
a program storage that stores an application program which treats and controls the multimedia file; and
an executing unit that executes the application program to enable the application program to communicate with the sequencer for effecting a control of the parallel running of the sequence tracks including a start control and a stop control of the parallel running of the sequence tracks.

2. The multimedia system according to claim 1, wherein the file storage stores the multimedia file composed of the sequence tracks further including an audio sequence track which records audio sequence information.

3. The multimedia system according to claim 1, wherein the file storage stores the multimedia file composed of the sequence tracks further including a master sequence track which records the synchronization information to constitute said synchronization means.

4. The multimedia system according to claim 3, wherein the master sequence track records the synchronization information containing control information effective to control a progression of each sequence track along a time axis.

5. The multimedia system according to claim 1, wherein the drawing sequence track records the drawing sequence information which is constituted by a sequence of display events and durations, the display event indicating a display object which is drawn during the running of the drawing sequence track, the duration indicating a time interval between a pair of successive display events.

6. The multimedia system according to claim 5, wherein the display event includes layout information effective to specify a position of the display object relative to a display screen in a plurality of coordinate formats according to a size of the display screen and a size of the display object.

7. The multimedia systems according to claim 5, wherein the display event comprises a primary block containing definition information effective to define the display object, and a secondary block containing modification information effective to impart movements to the display object, the modification information being selected to impart one or more of different movements which are independent from one another and which do not interfere with one another.

8. A multimedia file comprising:
sequence tacks including a performance sequence track that records performance sequence information, and a drawing sequence tack that records drawing sequence information; and
a synchronization means that records synchronization information effective to synchronize the sequence tracks with one another, wherein
the multimedia file is processed by a sequencer for parallel running of the sequence tracks synchronously with each other according to the synchronization information, and wherein
the multimedia file is used by an application program, which is executed to communicate with the sequencer for effecting a control of the parallel running of the sequence tracks including a start control and a stop control of the parallel running of the sequence tracks.

9. A method of playing a multimedia file by combination of a sequencer and an application program, the multimedia file being composed of sequence tacks including a performance sequence track recording performance sequence information and a drawing sequence tack recording drawing sequence information, and a synchronization means recording synchronization information effective to synchronize the sequence tracks with one another, the method comprising the steps of;
processing the multimedia file by the sequencer for parallel running of the sequence tracks synchronously with each other according to the synchronization information; and
executing the application program to communicate with the sequencer for effecting a control of the parallel running of the sequence tracks such as a start control and a stop control of the parallel running of the sequence tracks.

10. The method according to claim 9, wherein the multimedia file further includes an audio sequence track which records audio sequence information.

11. The method according to claim 9, wherein the multimedia file includes a m aster sequence track which records the synchronization information to constitute said synchronization means.

12. The method according to claim 11, wherein the master sequence track records the synchronization information containing control information effective to control a progression of each sequence track along a time axis.

13. The method according to claim 9, wherein the drawing sequence track records the drawing sequence information which is constituted by a sequence of display events and durations, the display event indicating a display object which is drawn during the running of the drawing sequence track, the duration indicating a time interval between a pair of successive display events.

14. The method according to claim 13, wherein the display event includes layout information effective to specify a position of the display object relative to a display screen in a plurality of coordinate formats according to a size of the display screen and a size of the display object.

15. The method according to claim 13, wherein the display event comprises a primary block containing definition information effective to define the display object, and a secondary block containing modification information effective to impart movements to the display object, the modification information being selected to impart one or more of different movements which are independent from one another and which do not interfere with one another.
